(19) United States
(12) Patent Application Publication
(10) Pub. No.: US 2024/0300629 A1
(43) Pub. Date: Sep. 12, 2024

(54) Shared Autonomy for Remote Collaboration

(71) Applicant: Woods Hole Oceanographic Institution, Woods Hole, MA (US)

(72) Inventors: Richard CAMILLI, Falmouth, MA (US); Amy PHUNG, Worcester, MA (US); Gideon BILLINGS, Falmouth, MA (US); Mathew WALTER, Chicago, IL (US); Andrea DANIELE, Belmont, MA (US)

(21) Appl. No.: 18/596,831

(22) Filed: Mar. 6, 2024

Related U.S. Application Data
(60) Provisional application No. 63/450,119, filed on Mar. 6, 2023.

(51) Int. Cl. B63G 8/00; B64G 1/24

(52) U.S. Cl. CPC B63G 8/001; B63G 2008/007; B64G 1/24

(57) ABSTRACT

A SHared Autonomy for Remote Collaboration (SHARC) framework enables distant human users to collaboratively plan and control manipulation tasks using interfaces that provide a contextual and interactive 3D scene understanding. A 3D module is configured to generate a three-dimensional workspace image of a robot workspace utilizing at least one imaging sensor directed at the site. A local server communicates directly with the robot and has at least one local user interface. At least one remote server communicates wirelessly with the local server and with one or more remote user interfaces. A robot autonomy module receives interface inputs from the local user interface and the remote user interfaces, develops an action plan utilizing the interface inputs, and coordinates with the local server to provide instructions to the robot.

### CROSS-REFERENCE TO RELATED APPLICATION

This application claims priority to U.S. Provisional Application No. 63/450,119 filed on 6 Mar. 2023. The entire contents of the above-mentioned application are incorporated herein by reference as if set forth herein in entirety.

### STATEMENT REGARDING GOVERNMENT LICENSE RIGHTS

The invention described herein was made with U.S. government support under National Robotics Initiative Grant Nos. U.S. Pat. Nos. 1,830,500 and 1,830,660 awarded by the National Science Foundation and Analog Research Grant No. NNX16AL08G awarded by the National Aeronautics and Space Administration. The U.S. Government has certain rights in the invention.

### FIELD OF THE INVENTION

This invention relates to remote human collaborative manipulation of robots such as remotely operated vehicles.

### BACKGROUND OF THE INVENTION

Exploration and operation in the deep ocean beyond SCUBA (Self-Contained Underwater Breathing Apparatus) diving depth is vital for improved understanding of natural Earth processes as well as management of subsea infrastructure and marine resources. However, inaccessibility remains a fundamental challenge for these activities. Technological innovations in marine robotics provide a path forward for substantively improving the efficiency and geospatial precision of benthic operations requiring physical manipulation tasks, while also increasing societal engagement and understanding of oceanographic processes.

Currently, dexterous sampling tasks at depth are performed by underwater remotely operated vehicles (ROVs) equipped with robotic manipulator arms. ROV pilots directly teleoperate these manipulators with a topside controller in a shipborne control room containing numerous video and telemetry data displays. However, teleoperation has several limitations that sacrifice the effectiveness and efficiency of the tasks being performed. First, it places significant cognitive load on the operator, who must reason over both the high-level objectives (e.g., sample site selection) and low-level objectives (e.g., determine arm motions required to achieve a desired vehicle and end-effector pose, while constructing a 3D scene understanding from 2D camera feeds).

Second, ROV operators typically exercise one joint angle at a time in a “joint-by-joint” teleoperation mode when using conventional control interfaces, which restricts dexterity, limits efficiency, and can be error-prone when operating over a time-delayed, bandwidth-constrained channel. Thus, conventional ROV operations require a high-bandwidth, low-latency tether, which limits the ROV's manoeuvrability and increases the infrastructure requirements. Despite these limitations, direct teleoperation is still the standard approach for benthic sampling with ROVs.

Moreover, access to ROVs for sampling remains prohibitively expensive for many researchers since their operation requires a surface support vessel (SSV) with a highly trained operations crew, and SSV space constraints limit the number of onboard participants. Expanding shore-based access for remote users to observe and control robotic sampling processes would increase the number of users and observers engaged in the deployment while reducing barriers to participation (e.g., physical ability, experience, or geographic location). However, the conventional direct-teleoperation approach is infeasible for remote operators due to the considerable bandwidth limitations and high latency inherent in satellite communications, and thus some degree of ROV autonomy is currently required.

Although methods for autonomous underwater manipulation are advancing, contextual awareness in unstructured environments remains insufficient for fully autonomous systems to operate reliably. Recent work has explored learning-based approaches to infer human intent in order to increase an autonomous system's robustness to bandwidth limitations during remote teleoperation.

While low-dexterity tasks are now possible using autonomous underwater intervention systems in unstructured natural environments, improved modes for human-robot collaboration still hold promise for expanding operational capabilities and increasing trust in human-robot systems. User studies comparing novel VR (Virtual Reality) interfaces to industry standard control methods found that VR reduced task completion times while also reducing the cognitive load for operators. Even when the ROV control method is left unchanged, a recent study demonstrates that a 3D VR interface increases pilots' sense-of-presence over a conventional 2D visual interface and reduces task completion time by more than 50%. See, e.g., A. Elor et al., in Proceedings of the 27th ACM Symposium on Virtual Reality Software and Technology, pp. 1-10 (2021).

Similar to how interface improvements can reduce an operator's cognitive load and task completion times, relaxing human proprioception and motor control requirements can further reduce cognitive demand. Natural language (NL) speech and gesture interfaces provide a succinct mechanism for high-level, goal-directed control. If made sufficiently expressive, NL has the potential to increase task efficiency (i.e., speed and precision) by decoupling human operator dexterity from manipulator control. This becomes particularly beneficial in domains like remote underwater manipulation which involve low-bandwidth, high-latency communication. Natural language and gestures are intuitive and thereby provide a means of command and control that is accessible to a diverse user base with little prior training. However, conventional approaches to NL understanding typically require that the environment be known a-priori with a so-called “world model” that expresses its semantic and metric properties. This shared representation requirement for unstructured environments on Earth, both terrestrial and underwater, as well as extraterrestrial environments including oceans that may be found beyond Earth remains as an open problem for the robotics community.

### SUMMARY OF THE INVENTION

An object of the present invention is to provide an improved system for remotely and collaboratively operating robots in structured and unstructured environments.

Another object of the present invention is to provide such a system which enhances simultaneous collaboration among a team of remote (off-site) operators for observation, scene annotation, and directed robotic intervention.

Yet another object of the present invention is to provide such a system that accommodates low-bandwidth and/or high-latency communications during robotic operation.

A still further object of the invention is to provide such a system that is readily extensible to a variety of hardware architectures, including terrestrial and space-based systems.

This invention features systems and methods of remote human collaborative manipulation of one or more components of robots such as remotely operated vehicles in a workspace at a site. A 3D module is configured to generate a three-dimensional workspace image of the workspace utilizing at least one imaging sensor directed at the site. A local server communicates directly with the robot and has at least one local user interface through which the three-dimensional workspace image is viewable. At least one remote server communicates wirelessly with the local server and with one or more remote user interfaces through which the three-dimensional workspace image is viewable. A robot autonomy module receives interface inputs from the local user interface and the remote user interfaces, develops an action plan utilizing the interface inputs, and coordinates with the local server to provide instructions to the robot.

In some embodiments, the local server includes a personal computer configured to operate at least a portion of the robot autonomy module. In certain constructions, the 3D module is configured to receive inputs from a stereo camera, such as a pair of cameras, directed at the workspace. Some constructions include one or more other sensory devices such as sonar, lidar, radar, or x-ray imaging. In some embodiments, the 3D module is further configured to receive input from a camera, such as a fisheye or wide-angle camera, or other sensory device mounted on the component, such as an articulated manipulator arm, of the robot to view at least a portion of the workspace. In some embodiments, the 3D module is further configured to receive input from acoustic sensors, such as imaging sonars, mounted on the component, such as an articulated manipulator arm, of the robot to view at least a portion of the workspace. In some embodiments the 3D module can configured to fuse sensor inputs, including but not limited to optical, acoustic, electro-magnetic, and position sensor feedback.

A number of embodiments further include the robot, and the component is an articulated manipulator assembly. In some embodiments, the robot is configured to operate in a liquid, such as a lake or an ocean, at a site below a surface of the liquid. In certain embodiments, the robot is an underwater vehicle operatable without a human occupant. In other embodiments, the robot is configured to operate in one or more of aerial or space flight, land-based, space-based or extraterrestrial environments. In some embodiments, the system is configured to update the three-dimensional workspace image according to bandwidth availability and/or latency for communications among the user interfaces, the local server, the remote server, and the robot.

In certain embodiments SHARC can optimize trade-offs between execution time, power requirements, and accuracy during manipulation. For example, a model predictive controller can be used to enable faster actuation rates while minimizing overshoot and inferring accuracy requirements based on the user's actions to scale the planning and execution times accordingly. A visual servoing-based controller can be integrated into SHARC for millimeter-level positioning accuracy. In some embodiments, SHARC's current plan-then-execute approach implicitly assumes the environment at the worksite is static. To avoid moving obstacles, other embodiments can incorporate dynamic replanning methods, which would route the arm around newly detected obstacles in the workspace. Augmenting the planner to optimize for trajectories that minimize power usage would also be valuable for vehicles that carry power onboard.

This invention also features a method including reproducing a three-dimensional workspace image of a workspace at a site utilizing at least one imaging sensor directed at the workspace at the site. A local server is selected to communicate directly with the robot and with at least one local user interface through which the three-dimensional workspace image is viewable. At least one remote server is selected to communicate wirelessly with the local server and with one or more remote user interfaces through which the three-dimensional workspace image is viewable. The method further includes designating a plurality of users as members of an operations team, and receiving interface inputs from the local user interface and the remote user interfaces from the members of the operations team, developing an action plan utilizing the interface inputs, and coordinating with the local server to provide instructions to the robot.

In some embodiments, the method includes designating at least one user as a field team member, who may also serve as a technical team member, of the operations team and selectively designating one or more remote users as remote team members who may serve as science team members. In some embodiments, one or more science team members are also on-site as local users and/or as field team members. In a number of embodiments, the field team member selectively delegates control authority to one of the remote team members to serve as a science operator having active task control of at least one parameter of the robot. Other users are designated as observers who receive data streams and the three-dimensional workspace image through at least one additional interface but without the ability to issue instructions to the robot.

In certain embodiments, at least one field team member is responsible for operations support including overseeing safety, managing communications, and selectively delegating control authority to other users. In some embodiments, at least one remote team member is responsible for operating payload instruments and/or generating task-level plans for use of the component, such as an articulated manipulator assembly, of the robot. In some embodiments, an automated motion planner generates task and/or motion plans for use of the component, such as an articulated manipulator assembly, of the robot. In certain embodiments, the three-dimensional workspace image is updated according to bandwidth availability and/or latency (lag or time delay) for communications among the user interfaces, the local server, the remote server, and the robot. In some embodiments, control authority is retained by at least one local user to serve as an operator having active task control to manipulate the component of the robot. The action plan may be developed utilizing only local user inputs, especially if any difficulties are encountered with communications from remote users. In one embodiment, the method further includes deselecting receipt of interface inputs from the remote user interface to enable full local control of the robot.

### BRIEF DESCRIPTION OF THE DRAWINGS

To enable a better understanding of the present invention, and to show how the same may be carried into effect, certain embodiments of the invention are explained in more detail with reference to the drawings, by way of example only, in which:

FIG. 1 depicts an overview of a SHared Autonomy for Remote Collaboration (SHARC) ship-based field operation utilizing an underwater ROV according to one embodiment of the present invention;

FIG. 2 is a schematic diagram of local, on-site components of the SHARC system, showing perception, control and action (motion path) planning processes relative to the ROV;

FIG. 3 is a schematic representation of real-time, in-situ X-ray fluorescence (XRF) analysis, illustrating one embodiment of the SHARC system managing a sampling process with remote scientists (science team members ST₁, ST₂ and ST₃) collaborating with the onboard field crew (technical team TT₁ and TT₂) to take an XRF measurement and push core sample of a microbial mat on the seafloor;

FIG. 4 depicts components within the SHARC framework including robot vehicle data sent via satellite communications from the ship to a shore-side server that handles the distribution of data to remote users and the return of instructions to the ship;

FIG. 5 depicts a simple GUI (graphical user interface) to the SHARC automated system enabling the user to configure and step through an automated pick-and-place pipeline;

FIGS. 6A-6C depict a user study testbed for block retrieval, FIG. 6A, and push core sampling, FIG. 6B, with tasks utilizing a hydraulic manipulator equipped with a basket for tools and samples, with FIG. 6C including an outline of the ROV illustrated in FIGS. 3-4 for comparison of workspace scale and tool movement within the workspace;

FIGS. 7A-7B depicts task rate breakdown, FIG. 7A, among test groups, expressed across framerates in FIG. 7B;

FIGS. 8A-8C depicts plots for Task Completion Times, T_{i,FPS}, for the block pick-up tasks, FIG. 8A, and push core tasks, FIG. 8B, as well as the Expected Task Times, E(T_{FPS}), FIG. 8C;

FIG. 9 is a graph depicting expected task times (E(Tₜᵣᵢₐₗ)) for the block pick-up task plotted by trial number;

FIG. 10 depicts a push core location map wherein the map of push core placement locations by test group is shown relative to the target center, with confidence ellipses (20) shown in dashed lines for each group;

FIG. 11 depicts a DCG (Distributed Correspondence Graph)-type factor graph in an upper row for the expression “get the pushcore from the tooltray”, middle row, aligned with an associated parse tree, bottom row, with first columns of nodes denoting observed random variables, while those in second columns are latent;

FIGS. 12A-12D depicts one embodiment of SHARC interfaces wherein the SHARC-VR interface, FIGS. 12A-12C, and SHARC-desktop interface, FIG. 12D enabled remote scientists to collect XRF and push core samples; and

FIG. 13 depicts a table of the SHARC features developed for each interface.

### DETAILED DESCRIPTION OF THE PRESENTLY PREFERRED EMBODIMENTS

One construction of the present invention includes a SHared Autonomy for Remote Collaboration (SHARC) framework that enables one or more off-site scientists or other “remote” people to participate in shipboard operations via one or more types of personal computers such as a VR headset or desktop interface at multiple client nodes. The SHARC framework enables distant human users to collaboratively plan and control manipulation tasks using interfaces that provide a contextual and interactive 3D scene understanding. SHARC extends conventional supervisory control concepts by enabling real-time, simultaneous collaboration between multiple remote operators at various geographic locations, who can issue goal-directed commands through various techniques including free-form speech (e.g., “pick up the push core on the right”), eye movement (e.g., visual gaze), and hand gestures (e.g., “thumbs-up” to execute an action plan such as a motion path plan). SHARC couples these natural input modalities with an intuitive and interactive 3D workspace representation, which segments the workspace and actions into a compact representation of known features, states, and policies.

As described below, SHARC users can participate as observers or as members of the operations team, which typically is subdivided into a field team, which typically includes one or more technical team members, and a science team of local and/or remote scientists. Any team member can be located anywhere in the world where there is an Internet connection.

As one working example, the SHARC framework enabled a remote science team to conduct real-time seafloor elemental analysis and physical sample collection with centimeter-level spatial precision in manipulator positioning within a workspace at a seafloor site. Through a controlled user study, it was demonstrated that SHARC enables skilled pilots as well as novices to complete manipulation tasks in less time than it takes the pilots to complete the same tasks using a conventional underwater manipulator controller, especially when operating in conditions with bandwidth limitations. These results indicate that SHARC enables efficient human-collaborative manipulation in complex, unstructured environments, and can out-perform conventional teleoperation in certain operational conditions.

SHARC is able to support novice “shore-side” or other remote-based users at one or more client nodes without requiring additional bandwidth from the ship or specialized hardware. This capability has real potential to democratize access to deep sea operations. The SHARC framework is readily extensible to other hardware architectures, including terrestrial and space systems.

The term “robot” as utilized herein refers to a machine, such as a vehicle, having some or all of the following abilities and functions: operate physical components of itself or physical processes; sense and manipulate its environment; movable to different physical locations; communicate with remote human operators; electronically programmable; and process data or sensory inputs electronically.

The term “server” as utilized herein refers to a computer server that interacts with a plurality of client nodes and at least one robot to share data and information resources among the client nodes and the robot, and includes (1) personal computers such as workstations, desktop, laptop or tablet computers that become servers, or share resources with a local server, when running software “collaborative framework” programs according to the present invention, (2) cloud-based servers acting as remote servers according to the present invention, and (3) computer network servers acting as hosts for overlay networks in communication with the robot.

The term “framework” as utilized herein refers to robotic architectures or robotic paradigms to handle sensing, planning and acting by and/or on behalf of a robot.

The term “articulated” as utilized herein refers to a manipulator assembly having at least one joint to enable bending of the assembly.

The term “extraterrestrial” as utilized herein refers to an environment beyond Earth's atmosphere and includes space-based structures such as satellites and space stations, asteroids, moons and planets.

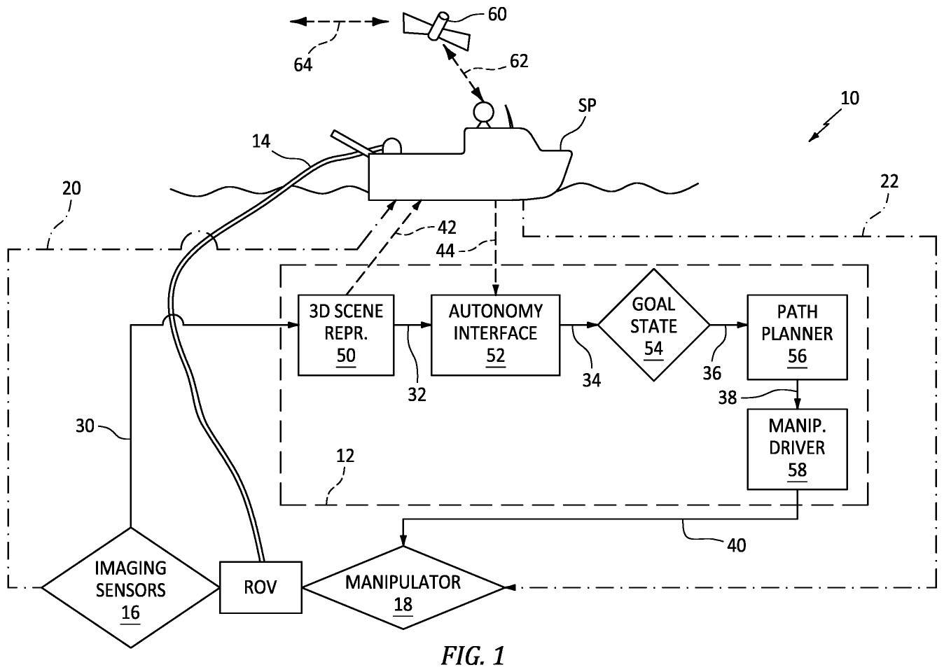

A SHARC system 10, FIG. 1, according to the present invention includes an autonomy module 12 which, in one construction, runs on a topside desktop computer or other personal computer on surface ship SP. Visual sensor data from imaging sensors 16 and manipulator coms controlling articulated manipulator 18 are streamed over a high bandwidth tether 14 from the robot vehicle ROV. Dash-dot data flow lines 20 and 22 represent standard teleoperated control from the surface ship SP. Solid flow lines 30, 32, 34, 36, 38 and 40 represent informational data flow from processing conducted by the SHARC system 10.

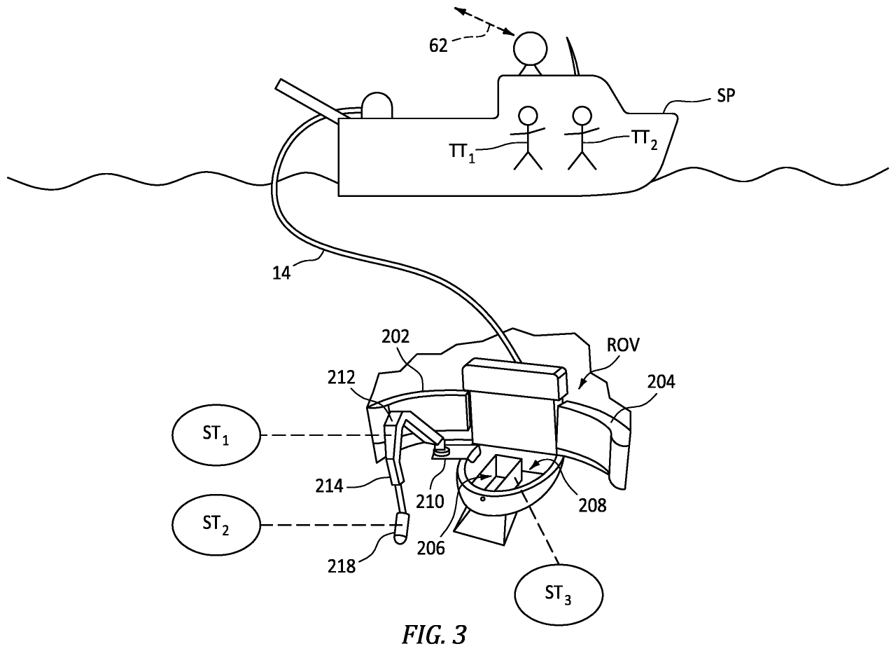

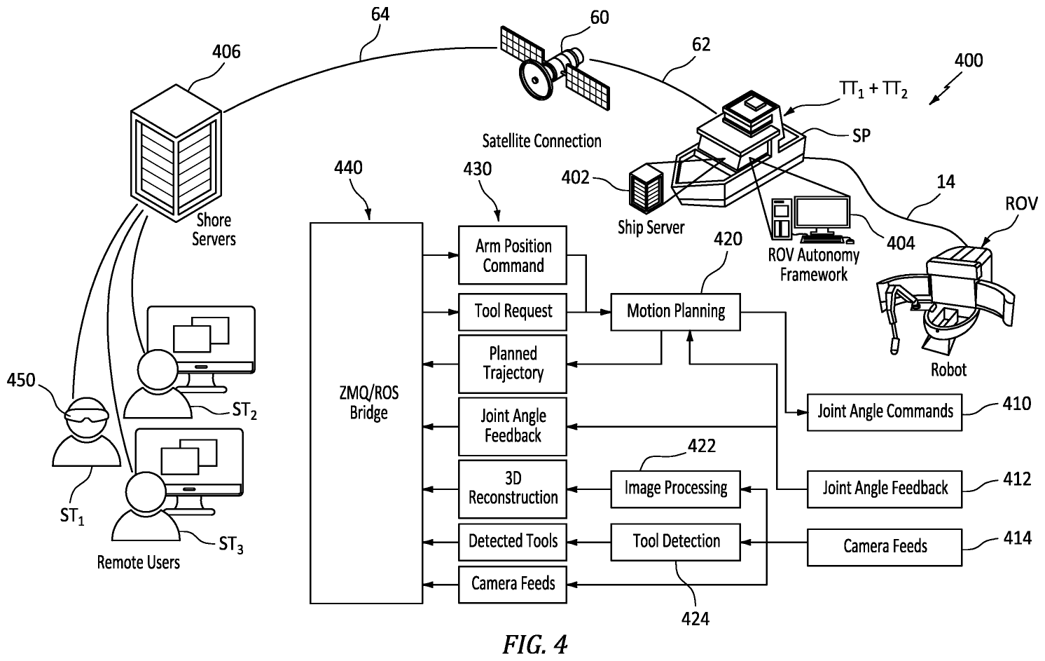

In this construction, the autonomy module 12, FIG. 1, includes 3D scene representation module 50, autonomy interface module 52, goal state determination module 54, path planner module 56 and manipulator driver 58. Dashed lines 42 and 44 represent interfacing between an ROV pilot and other users and the autonomy module 12, where, in one construction, the pilot acts as the high-level task planner and interfaces with the autonomy module 12 through a graphical scene representation and task level controller. In other constructions, the pilot would be supplemented or replaced with team members communicating wirelessly through a satellite 60 as shown by dashed lines 62, 64 as part of an automated mission planner that issues high-level tasks. In one implementation, the ROV is the NUI (Nereid Under Ice) Hybrid ROV (“NUI HROV”) illustrated schematically in FIGS. 3-4 and managed by the Woods Hole Oceanographic Institution, Woods Hole, Massachusetts.

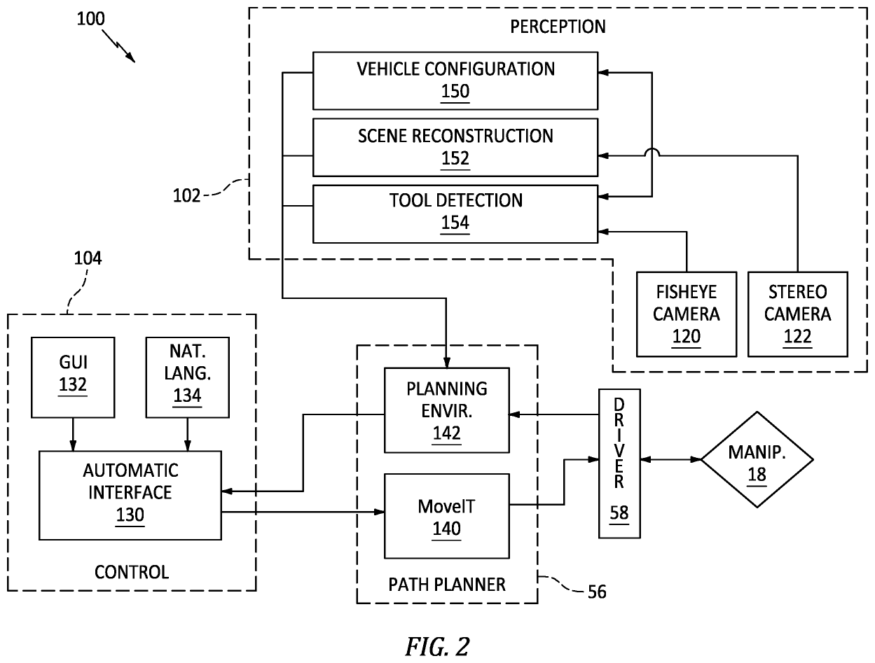

FIG. 2 is a schematic diagram of certain components 100 in one construction of the SHARC system 10, with perception module 102 utilizing a wide-angle field of view fisheye camera 120 and a stereo camera 122 directable at the manipulator arm 18, which is a manipulator assembly having at least one joint to enable bending of the arm 18, of the ROV shown in FIG. 1 as it moves within a workspace at a selected site. The perception module 102 uses the fisheye and stereo pair cameras 120, 122 to generate 3D reconstruction of manipulation workspace. Fisheye camera 120, when mounted near wrist 214 of manipulator arm 212, FIG. 3, provides a dynamic viewpoint which at times may be occluded or outside FOV (Field Of View) of the stereo pair 122, FIG. 1. Control module 104, FIG. 2, relates to high-level control via automatic interface module 130 receiving inputs from GUI interface 132 and a hands-free natural language interface 134 in this construction. Low-level control is represented by driver 58 which receives instructions from path planner 56 having a MoveIt! framework 140 and a planning environment module 142

In this construction, the stereo camera 122, FIG. 2, is utilized by (i) vehicle configuration module 150 to estimate the pose or positioning of the robotic vehicle and its components (e.g., the pose of the front doors 202, 204, FIG. 3, on the NUI HROV), (ii) scene reconstruction module 152, FIG. 2, to generate “point clouds” of the scene that can be fused to produce a 3D reconstruction of the scene, and (iii) tool detection module 154 to assist with tool localization such as by recognizing tool handle shape and/or markings or codes carried by the tools. In one construction, the fisheye camera 120 is used by tool detection module 154 to localize tools and obtain dynamic viewpoints of the workspace. For low-level control, a driver 58 implements a position-based trajectory controller, which integrates between MoveIt! module 140 and the manipulator valve controller. For high-level control, an automation interface 130 is implemented to MoveIt! 140 that supports high-level commands. In this construction, user interfaces includes a graphical front-end 132 as well as natural language abilities via interface 134.

Shared Autonomy for Remote Collaboration (SHARC) Framework. In one construction illustrated in FIGS. 1-4, the SHARC system includes four primary parts or modules: (i) a Robot Operating System (ROS)-type autonomy framework, represented by autonomy module 12, FIG. 1, with further details illustrated in FIGS. 2 and 4; (ii) a local ship-based server 402, FIG. 4, which includes at least one personal computer 404 in one construction; (iii) at least one remote shore-based server 406; and (iv) at least two remote shore-side user interfaces that are typically separated from each other geographically, shown as remote science team members ST₁, ST₂ and ST₃ in FIGS. 3 and 4. SHARC users can participate as observers or as members of the operations team that, in a number of constructions, is subdivided into a field team and a remote team; in some constructions, members of the operations team are designated as technical team members or as science team members. Observers receive data streams and the 3D scene reconstruction through one of SHARC's interfaces but are not able to issue manipulation commands.

FIG. 3 depicts a real-time, in-situ X-ray fluorescence (XRF) analysis according to one embodiment of the present invention by field team members serving as a technical team and remote team members serving as a science team, with at least some team members located remotely and communicating wirelessly as indicated by communications 62. The technical team TT₁ and TT₂ typically (but not necessarily) are “local” or “field” personnel such as onboard crew on ship SP that are responsible for operations support, which involves overseeing safety, managing communications, and selectively delegating control authority, also referred to herein as active task control.

In one construction shown in FIGS. 3-4, team member TT₁ designates a currently active remote science operator (i.e., the person who is delegated to have active task control) and team member TT₂ oversees ROV control and safety issues. In other words, team member TT₁ selectively delegates control authority, for a selected period of time or until another operator need arises, to one of the science team members to serve as an operator having active task control of at least one parameter of the robot. The science team members ST₁, ST₂ and ST₃ operate payload instruments 218 (e.g., XRF device operated by member ST₂), and/or generate task-level plans for sampling (e.g., member ST₃ issues verbal command for push core pickup from tool basket 206 in cargo area 208 of the ROV). One designated remote “science operator” (member ST₁ wearing VR headset 450, FIG. 4) controls the manipulator 212, FIG. 3, affixed to base 210, when member ST₁ is authorized by technical team member TT₁ to take an XRF measurement and push core sample of a microbial mat on the seafloor, for example.

In other constructions, one or more science team members are local field team members. Any team member (serving as an operator or otherwise contributing to manipulating the component of the robot) can be located anywhere in the world where there is an Internet connection. In some constructions, control authority is retained by at least one local user to serve as an operator having active task control to manipulate the component of the robot. The action plan may be developed utilizing only local user inputs, especially if any difficulties are encountered with communications from remote users. In one construction, receipt of interface inputs from one or more remote user interface is deselected to enable full local control of the robot.

FIG. 4 depicts key components within the SHARC framework including vehicle data (e.g., camera feeds, manipulator joint position feedback) sent by satellite communications 62, 64 from the ship server 402 via satellite 60 to shore-side server 406 that handles the distribution of data to remote users (e.g., science team members ST₁, ST₂ and ST₃) and the return of instructions to the ship SP. In one construction, the SHARC framework processes are distributed as follows. Joint angle commands 410, joint angle feedback 412 and camera feeds 414 reside on the ROV. Motion planning 420 resides on ROV Autonomy Framework personal computer 404. Image processing 422 and tool detection 424 also reside on computer 404 in one construction and, in another construction, reside on ship server 402. Various modules 430 (Arm Position Command, Tool Request, Planned Trajectory, Joint Angle Feedback, 3D Reconstruction, Detected Tools, and Camera Feeds) reside on ship server 402, which utilizes a ZMQ/ROS Bridge 440 as described in more detail below regarding ZeroMQ.

In one construction, the SHARC system is a cyber-instrument that can augment existing robot capabilities as a self-contained hardware package including a personal computer 404 or other local (e.g., ship-based) computer, imaging sensors including cameras and sonar or LIDAR (laser imaging detection and ranging) directable at a workspace to provide multi-modal perception, remote operator hardware, and software modules such as illustrated in FIGS. 1, 2 and 4. One suitable existing robot is the JASON ROV which has two articulated manipulator assemblies, with the potential to operate the assemblies cooperatively and simultaneously with each other. The JASON ROV is operated by Woods Hole Oceanographic Institution as part of the National Science Foundation's National Deep Submergence Facility based in Woods Hole, MA.

When pilots use a conventional topside controller to operate the manipulator, a reliable ˜15-20 hz connection is required between the vehicle and the controller, which is not attainable with a satellite link. To enable manipulator control by remote operators, SHARC utilizes a path planner 56, FIG. 2, similar to a ROS-based autonomy framework described by Billings et al. in “Towards Automated Sample Collection and Return in Extreme Underwater Environments, June 2022, Vol. 2, pp. 1351-1385 (“Billings 2022 Article”). This ROS autonomy framework was built on Movelt! to perform low-level trajectory planning and manipulator control. One example of MoveIt! represented by module 140, FIG. 2, is described by S. Chitta, I. Sucan, S. Cousins in Moveit! [ros topics], IEEE Robotics & Automation Magazine, 2012, Vol. 19, pp. 18-19. This framework tracks the manipulator's current pose, estimates tool poses using AprilTags (such as described by J. Wang, E. Olson, in 2016 IEEE/RSJ International Conference on Intelligent Robots and Systems (IROS), IEEE, 2016, pp. 4193-4198), and enables control of the arm via high-level objectives (e.g., tool pickup, moving the end-effector to a specified pose). Action plans such as motion path plans are described in more detail below.

The ship server 402, FIG. 4, runs on a ROS-enabled shipboard computer with nodes that interface with the ROS autonomy framework that, in some constructions, operates at least partially on a topside desktop personal computer 404 that shares resources with local ship server 402, and process the sensor streams into a continually updated 3D scene representation. To reduce the bandwidth needed on the ship-to-shore satellite connection, SHARC converts ROS messages to Concise Binary Object Representation (CBOR) messages to reduce their size before transmitting them with the high-performance messaging library ZeroMQ such as described by Chrin et al., “Accelerator Modelling and Message Logging with ZeroMQ”, 2015, Software Technology Evolution, Proceedings of ICALEPCS2015, ISBN 978-3-95450-148-9, Melbourne, Australia, pp. 610-614. The ship server 402 can also set limits on data framerates and pause selected sensor streams to control the amount of data sent over this link, to accommodate reduced bandwidth and/or high latency conditions.

The ship server 402 sends data (i.e., planned trajectories, joint angle feedback, camera and other imaging sensor feeds, the 3D scene reconstruction, and tool detections) through the satellite link 60, 62, 64 to the shore server 406, which then forwards this information to the remote onshore users (e.g., science team members ST₁, ST₂ and ST₃). The shore server 406, which is implemented in some constructions as a cloud-based server, authenticates remote users using pre-shared credentials to distinguish between members of the operations team and observers. The shore server 406 also makes sure that only the current “science operator” can submit manipulator commands and that these are forwarded to the ship server. Members of the operations team can issue verbal high-level commands (e.g., “pick up the push core,” “move the arm forwards”). The shore server 406 employs an instance of the Distributed Correspondence Graph (DCG) model to infer the corresponding structured language command. See, e.g., T. M. Howard et al., A Natural Language Planner Interface for Mobile Manipulators, in 2014 IEEE International Conference on Robotics and Automation (ICRA 2014), pp. 6652-6659. When parsing natural language commands, SHARC considers the current 3D scene understanding to distinguish tools based on their relative positions (e.g., left or right) or tool type (e.g., push core or XRF).

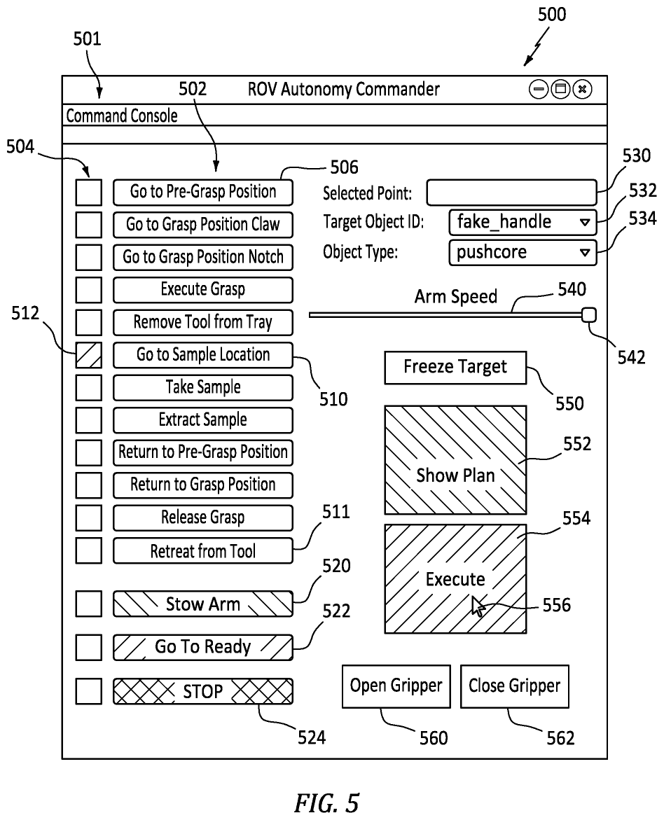

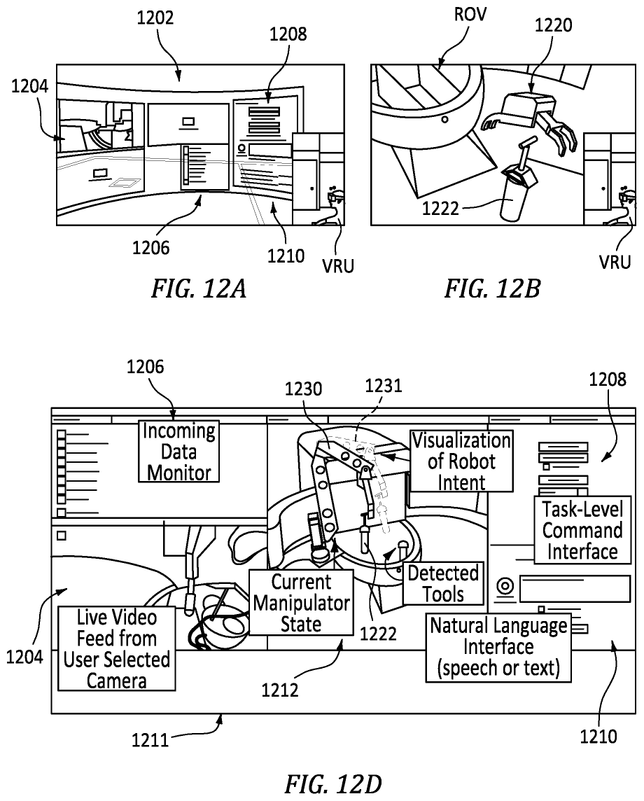

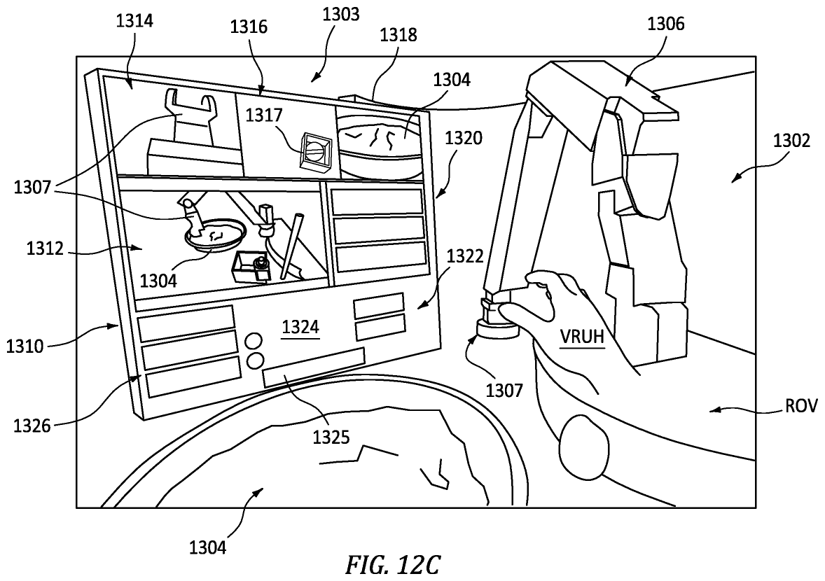

An easy-to-use GUI (graphical user interface) 500, FIG. 5, to the automated SHARC system enables the user to configure and step through a pre-selected action plan such as an automated pick-and-place pipeline, in this example an action plan of taking a push-core sample utilizing a grasper on an articulated manipulator arm such as carried by the NUI HROV. The action plan, also referred to as a “motion plan” when manipulator arm movement is selected, for each step is visualized in a planning scene (i.e., in a planning stage) and is only executed upon confirmation by the user, which provides a high level of safety for the system to be deployed on ocean-going systems. A visualization of robot intent is illustrated in FIG. 12D, for example.

The interface 500, FIG. 5, visualizes the manipulator motion plan at each step and only proceeds to execute the plan after the operator provides confirmation. This visualization can be shared with other participants. In some constructions, one or more other people (such as other team members or observers) participate in the review and/or confirmation of particular plans. The interface 500 allows the user to select a target among a set of tools detected in the scene and then activate a sequence of automated steps to grasp and manipulate the target using predefined grasp points for a grasper or other end-effector of the manipulator arm. An interactive marker enables the user to indicate the desired sample location in the 3D planning scene. Besides the pick-and-place state machine controller, the interface enables one-click planning of the manipulator to a set of predefined poses, immediate stopping of any manipulator motion, and opening and closing of the gripper. The MoveIt! planning environment also allows the operator to command the manipulator to an arbitrary configuration within the workspace through an interactive 3D visualization.

In this example, interface 500 is configured as a “Command Console” 501 to have a left-hand column of action steps 502 as programmable “soft buttons” beginning with “Go to Pre-Grasp Position” as button 506 and continuing with “Go to Grasp Position Claw”, “go to Grasp Position Notch”, “Execute Grasp”, “Remove Tool from Tray”, “Go to Sample Location” as button 510, “Take Sample”, “Extract Sample”, “Return to Pre-Grasp Position”, “Return to Grasp Position”, Release Grasp“, and “Retreat from Tool”, icon 511. A column 504 of status indicator icons includes icon 512 that, in one construction, is highlighted in “green” color as indicated schematically in FIG. 5 to shown that the motion plan is currently at the step of “Go to Sample Location”, button 510. Three additional action buttons include “Stow Arm” 520 in blue, “Go To Ready” 522 in green, and “STOP” 524 in red in this construction.

On the right-hand side of the Command Console 501, there is a “Selected Point:” field 530, a “Target Object ID:” field 532 which is currently set to “fake_handle” as a training exercise, and “Object Type:” field 534 currently set to “pushcore” as an indicator of tool type. A horizontal bar 540 controls “Arm Speed”, with slider icon 542 moved fully to the right in this example to show maximum speed for arm movement. Further icons in FIG. 5 include “Freeze Target” 550, “Show Plan” 552 in blue, “Execute” 554 in green with cursor 556 positioned to click on button 554. Further control buttons include “Open Gripper” 560 and “Close Gripper” 562 to enable rapid, real-time control of a grasper.

The SHARC system builds on prior approaches to UVMS (underwater vehicle manipulator system) control, in one construction effectively integrating the Movelt! motion planning framework, as described in the Billings 2022 Article and references cited therein, with a work-class ROV manipulator system for automated planning and control in obstructed scenes. The SHARC system provides a decoupled approach to manipulator control that assumes that the vehicle holds station (i.e., rests on the seafloor or other fixed surface) during the manipulation task. This assumption is motivated by the goal of having the system widely transferable among existing ROV systems. This decoupled approach enables the manipulator control system to be integrated externally from the existing UVMS control systems, providing high-level autonomy with flexibility to be integrated onto a wide array of vehicle and manipulator systems.

While many existing methods tightly couple vehicle and manipulator motion planning and control, our approach decouples the manipulator and imaging system from other systems on the ROV. This makes it easier to integrate the system with different ROVs and also minimizes risk to the vehicle, as the automation system runs independently of the vehicle's software. This approach also mimics standard ROV operation procedures, in which one pilot controls the vehicle while another pilot controls the manipulator. Our system seeks to replace the direct pilot control of the manipulator with a high-level automation interface that naturally integrates with standard ROV operational procedures.

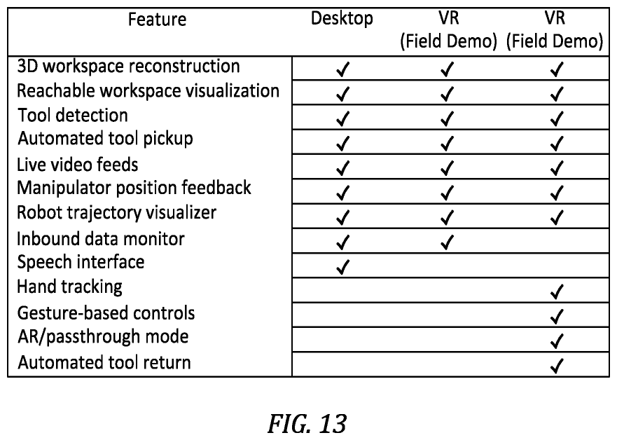

SHARC's VR and desktop computer interfaces display a model of the manipulator's current pose with a 3D stereo reconstruction of the scene and 2D camera feeds in the background and/or in different “windows” or panels, such as illustrated schematically for several constructions in FIGS. 12A-12D with the SHARC features developed for each interface listed in FIG. 13. Through one or more interfaces, users can collaboratively identify target sample sites based on real-time data and defer low-level control of the manipulator to the automated system including automatic features such as “Auto-Pickup Tool” and “Auto-Return Tool” 1326, FIG. 12C. FIGS. 12A-12D depict real-time and testing/training embodiments of SHARC interfaces wherein the SHARC-VR interface, FIGS. 12A-12B, and SHARC-desktop interface, FIG. 12D, enabled remote scientists to collect XRF and push core samples. A VR training session is depicted in FIG. 12C. The desktop interface screenshot 1211, FIG. 12D, includes annotations highlighting SHARC's key features, which are also present in selected amounts in the VR interface, FIG. 12A. Various scene annotations can be made by active operators, other team members, or observers depending on pre-selected system configuration. In some constructions, each user and/or observer can independently configure his or her perspective of the remote workspace image, including selecting different points of view such as by activating or accepting feeds from different image sensors, to control his/her perspective independently.

A Virtual Reality user VRU is depicted in the lower right-hand corner of FIGS. 12A-12B with a multi-image VR scene 1202, FIG. 12A, including live camera feed 1204, an Incoming Data Monitor screen 1206, a Task-Level Command Interface 1208 and a Natural Language Interface (speech or text) interface 1210 as shown in more detail in the desktop monitor screenshot 1211 of FIG. 12D.

A 3D representation of a grasper 1220, FIG. 12B, of a robot ROV is manipulated relative to a handle on tool 1222 by user VRU in FIG. 12B. A similar representation of Current Manipulator State 1212, FIG. 12D, includes the present pose of manipulator arm 1230 plus a “Visualization of Robot Intent”, shown in phantom as potential position 1231 after arm 1230 has grasped and moved tool 1222. This representation in three dimensions within a workspace of present and planned manipulator poses enhances obstacle avoidance and coordination of tasks.

A virtual reality view 1302, FIG. 12C, with robot ROV, shows a test participant's view from the VR headset during user testing. A blue background 1303 is replaced with a real-time view of the participant's physical environment to minimize their risk of bumping into walls and furniture. A VR user's hand VRUH is shown controlling the position of grasper 1307 of manipulator arm 1306 relative to a sandbox testbed 1304. The user can see a virtual interface 1310 that includes stereo camera view 1312 of grasper 1307 and sandbox 1304. Also included in this test construction are fisheye camera view 1314 of grasper 1307, a tool selection view 1316 including tool basket 1317, a target site view 1318 showing sandbox 1304, and recalibration soft buttons 1320 including “re-calibrate tool (in gripper)”, “re-calibrate tool (in environment)” and “re-calibrate [other selected feature]” or other pre-programmed feature. Two gripper-control soft buttons 1322 include “Open Gripper” and “Close Gripper”. Planning Status is shown in area 1324 with a “RESET” button 1325 below it. Buttons 1326 include “Visualize Plan”, “Auto-Pickup Tool”, and “Auto-Return Tool”.

Although VR (virtual reality) and NL (natural languages) are discussed herein for certain constructions, these are not limitations of the present invention. Words can be spoken, typed, or generated via gestures and/or eye tracking and visual gaze such as enabled by the VISION PRO headset available from Apple in Cupertino, California. Also, 3D scene reconstruction can be configured to distinguish between static and dynamic features, as well as human-made (structured) versus natural (unstructured) features. Multi-modal perception can include feedback from external sensors, including but not limited to optical, acoustic, and electromagnetic sensors (e.g. optical cameras, sonar acoustic, lidar, radar, and magnetic) as well as manipulator kinematic feedback and ROV navigation sensor data.

SHARC's user interfaces were created with Unity (Unity Technologies; San Francisco, CA) for nontechnical end-users. The desktop interface supported cross-platform operation, which was tested on Linux, Mac, and Windows machines. The VR interface only supported Windows and was developed and tested with an Oculus™ Quest 2 headset (available from Meta of Menlo Park, CA). No software development environment was needed for clients to use either of these interfaces. Other suitable headsets include the Microsoft Hololens2 and Apple® Vision Pro™ headset with AR (augmented reality) and “spatial computing” as well as VR capabilities.

Natural Languages. Subsea ROV missions require close collaboration between the ROV pilots and scientists. The primary means by which pilots and scientists communicate is through spoken language-scientists use natural language to convey specific mission objectives to ROV pilots (e.g., requesting that a sample be taken from a particular location), while the pilots engage in dialogue to coordinate their efforts. Natural language provides a flexible, efficient, and intuitive means for people to interact with our automated manipulation framework. The inclusion of a natural language interface supports a framework that can be integrated seamlessly with standard ROV operating practices and may mitigate the need for a second pilot.

The NUI HROV was utilized to perform a proof-of-concept demonstration of a task allocation architecture according to the present invention that allows user control of an ROV manipulator using natural language provided as text or speech using a cloud-based speech recognizer. Natural language understanding is framed as a symbol grounding problem, whereby the objective is to map words in the utterance to their corresponding referents in a symbolic representation of the robot's state and action spaces. Consistent with contemporary approaches to language understanding, we formulate grounding as probabilistic inference over a learned distribution that models this mapping.

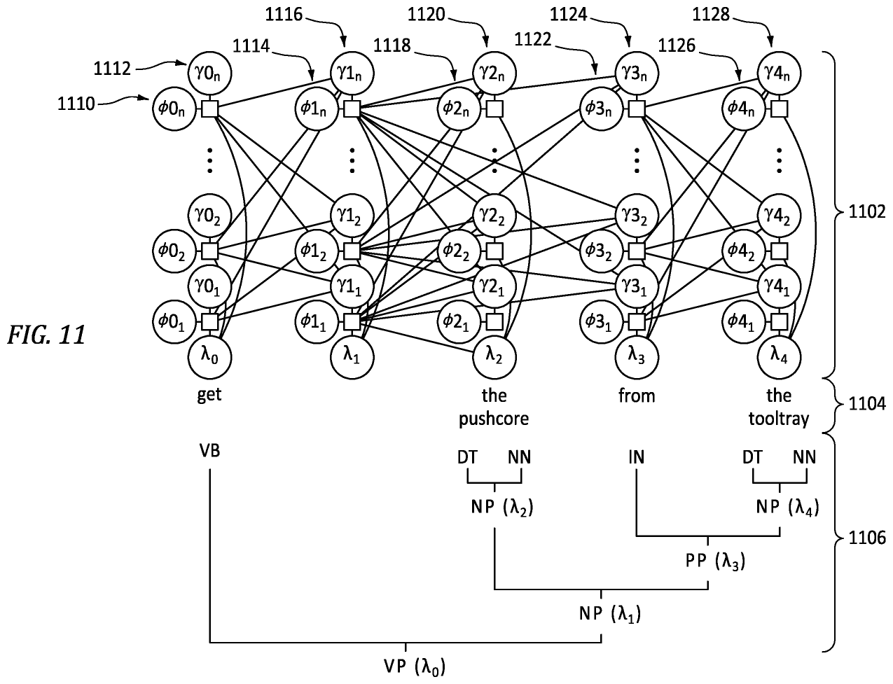

An inference can be made over referent symbols such as shown in FIG. 11 utilizing a variable that denotes the robot's model of the environment (e.g., the type and location of different tools). Similar to what is described in the Billings 2022 Article, FIG. 11 depicts a DCG (Distributed Correspondence Graph)-type factor graph in an upper row 1102 for the expression “get the pushcore from the tooltray”, middle row 1104, aligned with an associated parse tree, bottom row 1106, with first columns 1110, 1114, 1118, 1122 and 1126 of nodes denoting observed random variables, while those in second columns 1112, 1116, 1120, 1124 and 1128 are latent. This distribution can be modeled utilizing a DCG-type factor graph such as shown in upper row 1102 that approximates the conditional probabilities of a Boolean correspondence variable, that indicates the association between a specific symbol y, ET, which may correspond to an object, action, or location, and each word, E A. Critically, the composition of the DCG factor graph follows the hierarchical structure of language. The model is trained on a body of annotated examples (i.e., words from natural language utterances paired with their corresponding groundings) to independently learn the conditional probabilities for the different language elements, such as nouns (e.g., “the pushcore,” “tool,” and “tool tray”), verbs (e.g., “retrieve,” “release,” and “stow”), and prepositions (e.g., “inside” and “towards”). Together with the fact that the factor graph exploits the compositional nature of language, the DCG model is able to generalize beyond the specific utterances present in the training data.

Given input in the form of free-form text, either entered by the operator or output by a cloud-based speech recognizer, the SHARC system infers the meaning of the command using a probabilistic language model. In the case of the command to “go to the sample location,” for example, the SHARC system determines the goal configuration and solves for a collision-free path in configuration space. Given the command to “execute now,” the manipulator then executes the planned path to the goal.

User Study. To quantitatively compare the VR interface and the topside controller's performance, a user study measured the task completion time for participants carrying out a variety of representative manipulation tasks using each of the interfaces. The VR interface with partial autonomy for manipulation enables novice users to complete sampling tasks requiring centimeter-level precision in comparable or less time than experienced pilots using the conventional topside controller interface, and these performance benchmarks remain true when operating in low-bandwidth conditions. This performance extends to trained pilots; namely, experienced pilots are also be able to complete sampling tasks faster with SHARC than with the conventional topside controller interface. Participant task failure rate was measured to evaluate the interfaces' relative effectiveness during operations in standard and low bandwidth conditions.

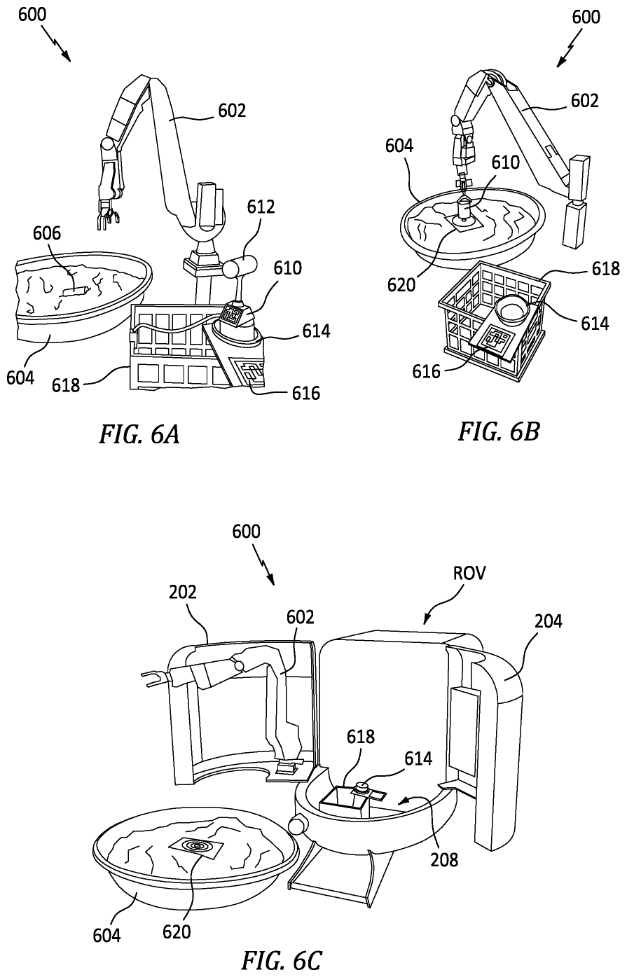

Experimental Setup & Testing Procedure. These tests were performed using an in-air testbed setup 600, illustrated schematically in FIGS. 6A-6C, with the same manipulator model (available from Kraft TeleRobotics in Overland Park, KS) as the one used for the field demonstrations. The testbed consisted of a seven degree-of-freedom (“DoF”) hydraulic manipulator 602 with a sandbox 604 that approximates the reachable workspace of the arm 602 when it is mounted on board the NUI HROV vehicle, as described in the Billings 2022 Article and illustrated in FIGS. 1-4 herein. The setup 600, FIGS. 6A-6C, includes cameras (not shown) and a tool basket 618 containing a push core 610 with their positions consistent with their placement onboard NUI HROV, shown in outline as ROV in FIG. 6C for comparison with setup 600. Push core tool 610 has a distinctive tool handle 612 and is stored in holder 614, marked by visual tag 616, within tool basket 618. As a proxy for an underwater imaging system (e.g., a stereo camera, a laser scanner, and/or imaging sonar), an Xbox One Kinect (available from Microsoft in Redmond, WA) was used to generate the 3D workspace reconstruction during user studies with the in-air testbed, such as described below in relation to FIGS. 12A-12D. The user study testbed setup 600 was utilized to retrieve block 606, FIG. 6A, and push core sampling, FIG. 6B, with tasks utilizing a hydraulic manipulator equipped with a basket for tools and samples, with FIG. 6C including an outline of the ROV with swinging doors 202, 204 and cargo hold 208 for comparison of overall scale of the workspace in testing and in the field.

The manipulator testbed 600 was located in an area separate from the participants in order to maximize safety. When learning how to use the topside controller, participants stood in the “training area” outside of the arm's workspace but maintained a direct line-of-sight to the physical arm. During testing, participants operated the arm from a separate room using either the VR or topside controller interfaces while an evaluator monitored the physical arm from the training area. When testing the SHARC-VR interface, the evaluator was able to observe the participant's headset view and the automated system's planned arm trajectories. The evaluator stopped the trial if the participant crashed the manipulator, caused an irrecoverable state (e.g. dropped a tool outside workspace), or exceeded 10 minutes in their attempt to complete the task.

Participants from the novice user group completed a 15-minute tutorial before completing timed trials with the VR interface and completed a 6-minute tutorial followed by 25 minutes of practice before testing with the topside controller interface. Pilots tested on the VR interface were given the same VR tutorial, while pilots tested on the topside controller were given a 10-minute “warm-up” period instead of a tutorial.

Participants completed two tasks with each of the interfaces: (1) picking up a wooden block 606, representative of a low-precision task (e.g. collecting rock samples), and (2) using a push core 610 to punch a hole in a printed “bullseye” 620, FIGS. 6B-6C, representative of a higher precision task (e.g., sampling a heterogeneous microbial mat on the seafloor). These tasks were repeated with a variety of camera feed framerates (referred to as a camera's FPS) to simulate the effects of bandwidth constraints of different orders of magnitude. The block pick-up task was tested at 10 FPS, 1.5 FPS, 0.5 FPS, 0.2 FPS, and 0.1 FPS. The push core task was tested at 10 FPS, 0.5 FPS, and 0.1 FPS. To measure sampling precision, the distance between the center of the punch in the sheet of paper 620 and the center of the printed “bullseye” was recorded.

In-situ Elemental Analysis with X-ray Fluorescence. Elemental analysis of the water column and ocean floor sediments was carried out in-situ using an X-ray fluorescence sensor developed at WHOI for automated analysis of deep ocean sediments with robotic vehicles. The XRF instrument is self-contained within a waterproof housing for operation to 2000 m water depth, with a 2.9 L internal volume. This instrument is similar in design to NASA's PIXL instrument onboard the Mars Perseverance Rover. Laboratory-based underwater testing demonstrates that the instrument can observe elements in the 2-50 keV spectral range with minimum limits of detection in the ppm range using integration times on the order of minutes. Sensitivity is, however, highly dependent on wavelength-dependent X-ray attenuation caused by mean through-water path length to the target.

Field Demonstration: In-situ X-Ray Fluorescence (XRF) Sampling. A team of remote operators conducted a dive operation in the San Pedro Basin of the Eastern Pacific Ocean with the SHARC-equipped NUI HROV (Nereid-Under-Ice vehicle). This shore-side team used SHARC's VR and desktop interfaces to collaboratively collect a physical push core sample and record in-situ XRF measurements of seafloor microbial mats and sediments at water depths exceeding 1000 m. With SHARC, the science team maintained the XRF in direct contact with the seafloor with centimeter-level positioning during sample acquisition, thereby reducing environmental disturbance to the work site.

FIG. 3 illustrates the in-situ XRF measurement process using SHARC. Although the remote science team was located more than 4,000 km away from the ship and relied on a low-bandwidth connection, SHARC enabled the team to sample visually distinct areas of the seafloor within and around a microbial mat. Real-time feedback from SHARC enabled active tuning of the XRF X-ray source and sensor integration parameters to maximize the signal-to-noise ratio while the sample was being collected. The XRF spectra revealed elevated concentrations of iron within the microbial mats, which suggested the presence of chemolithoautotrophs, (e.g., T. ferrooxidans). To independently determine the presence of these microbes, the remote science team then collected a physical push core sample from the same microbial mat with SHARC.

Quantitative Comparison to Conventional Interface: User Study. To quantitatively compare remote operations with SHARC against a conventional topside control interface for underwater manipulators, a user study was conducted. Participants formed four test groups as described above.

Participants completed representative manipulation tasks (i.e., placing a wooden block in a basket and taking a push core sample as described above in relation to FIGS. 6A-6C) in timed trials using the SHARC-VR interface and conventional topside controller. These trials were repeated under different visual update rates for the workspace environment, ranging from 10 frames per second (FPS) down to 0.1 FPS. Participants operated a laboratory-based (in-air) testbed setup 600, FIGS. 6A-6C, with the same manipulator model deployed on the NUI HROV in the field demonstrations.

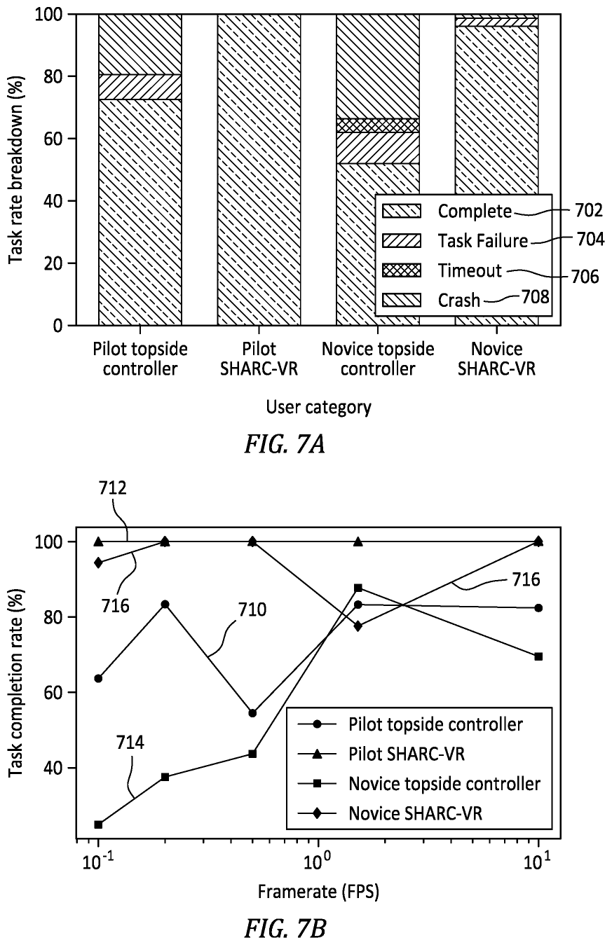

Across most framerates, both pilots and novices had a higher Task Completion Rate with SHARC-VR than with the topside controller. As shown graphically in FIG. 7A, each timed trial is labeled as “complete” (i.e., the participant successfully collected sample, coded as green 702), “failed” (i.e., the participant caused an unrecoverable state, such as dropping the block or tool out of reach, coded as yellow 704), “timed out” (i.e., the participant took too long to complete the task, coded as orange 706), or “crashed” (i.e., the evaluator stopped the arm to prevent collision damage, coded as red 708). The Task Completion Rates at each FPS, defined as Equation 1 are presented in FIGS. 7A-7B:

$${R}_{RPS} = \frac{\# successes}{\# trials} \qquad Eq . 1$$

As shown in FIGS. 7A-7B, SHARC significantly increased Task Completion Rates among pilots and novices, FIG. 7A, and across nearly all camera framerates, FIG. 7B, as shown by pilot topside controller line 710, pilot SHARC-VR line 712, novice topside controller line 714, and novice SHARC-VR line 716. This increase is most pronounced at low framerates; at 0.1 FPS, the completion rate among pilots and novices were, respectively, 57% and 278% higher with SHARC than with the conventional topside controller. On average, experienced pilots exhibited a higher completion rate than novices with both interfaces.

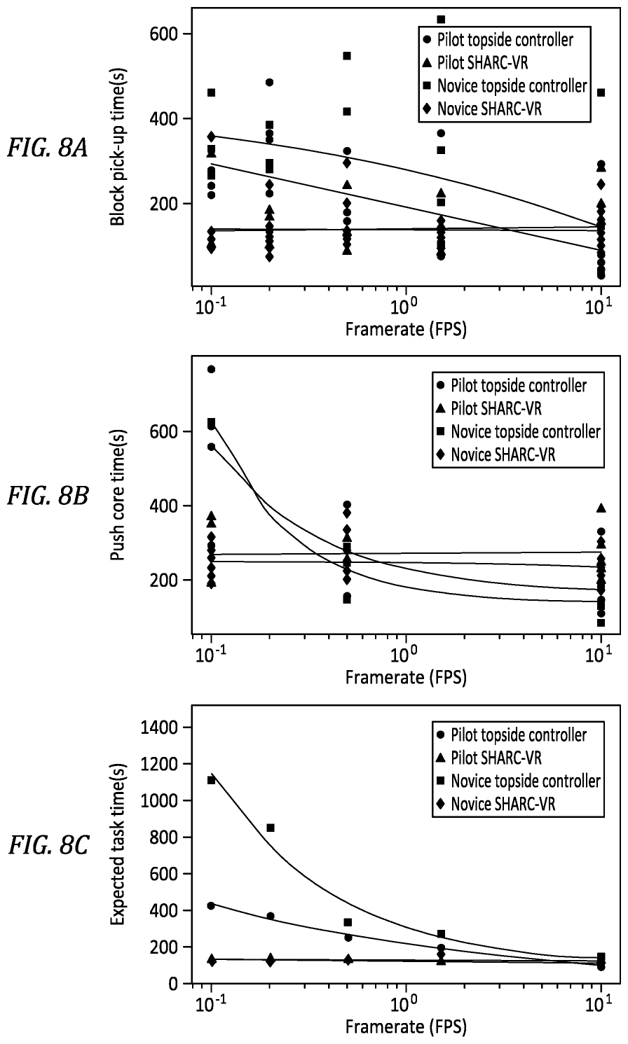

FIGS. 8A and 8B display the recorded Task Completion Times, T_{i,FPS}, for block-pickup and push core trials across framerates. FIG. 8C shows the Expected Task Times, E(T_{FPS}), across framerates, computed as the average recorded Task Completion Time, T̅_{FPS}, divided by the Task Completion Rate:

$${\overline{T}}_{FPS} = \frac{1}{{n}_{FPS}} {\sum }_{i = 1}^{{n}_{FPS}} {T}_{i , FPS} \qquad Eq . 2$$

$$E ( {T}_{FPS} ) = \frac{{\overline{T}}_{FPS}}{{R}_{FPS}} \qquad Eq . 3$$

Mathematically, this considers each trial as an independent event with a probability R_{FPS} of success, which implicitly assumes participants can retry failed tasks until successful. In FIGS. 8A-8C, a power curve is fit to the topside controller data because participants' times increased exponentially with decreasing framerates (FPS). For SHARC-VR, a linear trend is fit to the data because the times remained relatively constant across framerates. At decreased framerates, pilots and novices complete both the block pick-up and push core tasks quicker with SHARC-VR than with the topside controller. This difference is more pronounced among the Expected Task Times, which factors in the Task Completion Rate.

At 10 FPS, novices had a significantly lower expected time with SHARC-VR than with the topside controller (95% CI), but there was no statistically significant difference (95% CI) between pilots' expected time with both interfaces. At 0.5 FPS or less, the expected time for both pilots and novices was faster with SHARC-VR than with the topside controller, and this difference increased as the framerate decreased. At 0.1 FPS, the expected time was 2× faster for pilots with SHARC-VR than with the topside controller and 7.6× faster for novices. Across all framerates, there is no statistically significant difference (95% CI) between the expected time for pilots and novices when using SHARC-VR, and the variance in times with SHARC-VR is less than that of the topside controller for both groups.

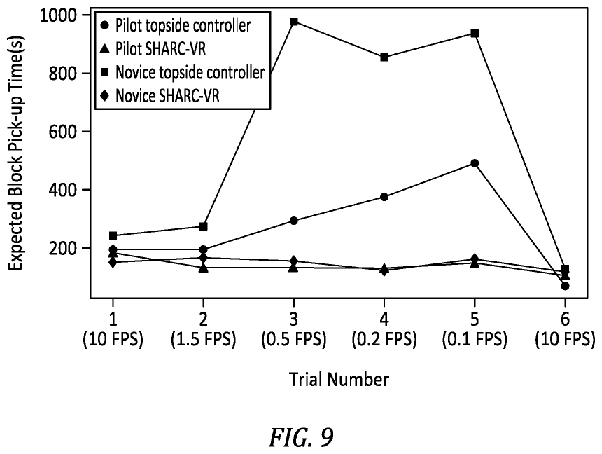

To more closely examine the learning among pilots and novices during testing, an Expected Task Time for the block pick-up was computed based on trial number instead of framerate, which we define as E (Tₜᵣᵢₐₗ). This analysis is presented in FIG. 9 as expected task times (E(Tₜᵣᵢₐₗ)) for the block pick-up task plotted by trial number. Initial and final trials are conducted at 10 FPS to control for framerate. SHARC-VR times exhibit a slight negative correlation with trial number independent of framerate, while topside controller times appear to be framerate dependent. The expected time with SHARC-VR appears to be linearly independent of framerate, with a slope of −9.7 s/trial for pilots and −6.6 s/trial for novices. This is not the case with the topside controller, wherein expected time appears to be dependent on framerate rather than trial number. The differences between the expected times of the first block pick-up trial (E(T₁)) and the last trial (E(T₁)) are recorded in Table 1:

TABLE 1

| | | | Absolute | Relative |
|---|---|---|---|---|
| | Initial | Final | Improvement | Improvement |
| | Time E(T₁) | Time E (T₆) | (E(T₆)- E(T₁) | $\frac{E ( {T}_{6} ) - E ( {T}_{1} )}{E ( {T}_{1} )}$ |
| Pilot topside controller | 195.0 | 72.7 | 122.3 | 63% |
| Pilot SHARC-VR | 183.8 | 107.4 | 76.4 | 42% |
| Novice topside controller | 244.2 | 129.3 | 114.9 | 47% |
| Novice SHARC-VR | 154.7 | 118.8 | 35.9 | 23% |

Table 1 lists expected task time (E(Tₜᵣᵢₐₗ)) improvement metrics wherein absolute and relative timing improvements for each test group between the initial and final block-pickup trials are shown. The absolute and relative improvements were smaller with the SHARC-VR interface than with the topside controller for both pilots and novices.

During the initial trial at 10 FPS, novices using SHARC-VR exhibited the fastest Expected Task Time. However, during the final trial at 10 FPS (˜30 min into testing), pilots using the topside controller were the fastest, which is consistent with their familiarity with conventional manipulation systems. For both operator groups, the differences between the first and last trials were smaller when using SHARC-VR than when using the topside controller.

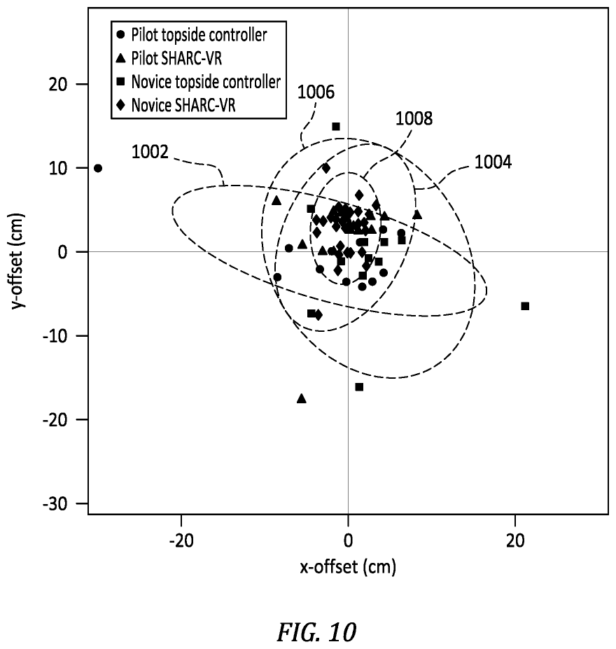

To quantify participants' accuracy and precision with the two interfaces, the push core locations are recorded relative to the center of a target. FIG. 10 visualizes this data, while Table 2 below presents the average accuracy and precision for each group. FIG. 10 illustrates the interfaces used during our field demonstration and depicts a push core location map wherein the map of push core placement locations by test group is shown relative to the target center. Confidence ellipses (26) are shown for each group: pilot topside controller line 1002, pilot SHARC-VR line 1004, novice topside controller line 1006, and novice SHARC-VR line 1008. For both pilots and novices, push core locations achieved using the SHARC-VR formed a tighter confidence ellipse than those with the topside controller.

As shown in Table 2 below, pilots using SHARC-VR were the most accurate across all groups, and the VR interface increased precision for both pilots and novices. Novices using SHARC-VR had the best precision (confidence ellipse 1008, FIG. 10), but the worst accuracy of all test groups. On average, using the VR interface instead of the topside controller decreased the variance between participants' placement position by ˜30% for pilots and ˜52% for novices. Pilots and novices using the topside controller had comparable accuracy and precision.

TABLE 2

| | Accuracy | Precision |
|---|---|---|
| | (cm) | (cm) |
| Pilot topside controller | 2.3 | 7.0 |
| Pilot SHARC-VR | 1.7 | 4.9 |
| Novice topside controller | 2.5 | 6.8 |
| Novice SHARC-VR | 2.8 | 3.3 |

For teleoperation of ROV manipulators, it is standard practice to stream multiple high-definition (HD) camera feeds at 30 Hz to the operating pilots. In the most bandwidth-constrained circumstances, compressed standard-definition (SD) cameras can be streamed at 10 Hz to the pilots. At lower image resolutions or frame rates, it becomes difficult for pilots to teleoperate the manipulator safely. The SHARC system enables high-level command of the manipulator and mitigates the need for continuous image streams back to the controlling pilot. Single image frames need only be sent when a scene change is detected or on request.

Other embodiments of the perception module 102, FIG. 2, of the SHARC system can utilize methods for semantic-level scene understanding to further reduce the need for direct image streams back to the pilot. For a semantic-aware system, natural language is well suited for human-machine interaction and can reduce the data communication load between the vehicle platform and a remote operator by onboarding data-heavy computation (e.g., image processing) onto the vehicle's local compute system and interfacing with the remote operator through small-bandwidth language packets. For the SHARC system to operate with pilot oversight, high-level commands and sensory feedback need only be streamed at rates that match the dynamics of the scene. The relevant scene dynamics can be on the order of seconds, minutes, or longer, enabling significant reduction of the communication bandwidth required for remote operations over bandwidth-limited connections, such as satellite links.

Table 3 below shows estimated bandwidth range requirements for the manipulator coms and image streams necessary to support direct teleoperation of an ROV manipulator system compared to the bandwidth requirements for natural language communication with the vehicle and only the necessary scene state feedback to inform the high-level commands. In the case of direct teleoperation, the manipulator coms can range from 15 to 200 Hz two-way communication with a typical packet size of 18 B. We estimate the image bandwidth for a single SD or HD camera with compressed data streamed at 10-30 Hz, though generally multiple camera views are streamed simultaneously back to the pilot for safe manipulator control. In the case of our high-level automation system, the natural language data rates are based on approximate estimates for the average letter count per word and the speech rate. This data rate represents the expected maximum bandwidth load when transmitted in real-time, as language-based communication is intermittent and can be compressed. The scene state feedback includes the vehicle state such as the manipulator joint states and semantic information, such as the type and pose of detected tools. However, the visual scene state feedback takes up the bulk of the bandwidth and is assumed to be encoded as a compressed camera frame or view of the 3D scene reconstruction. As demonstrated in Table 3, communication requirements to support the SHARC high-level system reduce the necessary bandwidth load by at least an order of magnitude compared to the requirements of the most limited direct teleoperation modality.

Comparison of the bandwidth requirements are listed in Table 3 below for direct teleoperation (top two rows) of an ROV manipulator system compared to operating our high-level SHARC autonomy system (bottom two rows), running onboard the vehicle with communication through natural language commands and only the necessary scene state feedback to inform the high-level commands.

TABLE 3

| Mode | Data Type | Bandwidth | |
|---|---|---|---|
| Teleoperation | Compressed SD or HD @ | 100 KB/s-3 MB/s | |
| Cameras | 10-30 Hz | | |
| Teleop. Manip. | 2 way × 15-200 Hz × 18 B | 540 B/s-7.2 KB/s | |
| Coms | | | |
| Natural | 1 B/letter × ~7 letters/ | 17.5 | B/s |
| Language | word × ~2.5 words/s | | |
| Scene State | State and Compressed | 3-30 | KB/s |
| Feedback | Images @ 0.1-1 Hz | | |

Discussion Currently, deep-ocean exploration requires substantial resources, and limited crew berthing on ships restricts the number of onboard participants during ROV operations. This presents multiple barriers to access for those who may lack the resources, time, or physical ability required for at-sea participation in oceanographic research. Deep-sea sampling is often conducted conventionally using a topside controller interface that requires a substantial learning investment by pilots and is configured specifically for each manipulator arm model. Operators typically control manipulators in a joint-by-joint fashion, which requires them to constantly determine the joint angles necessary to achieve a desired end-effector pose. Acquiring proficiency in manipulator teleoperation is challenging because the high cost of infrastructure for underwater manipulation limits the time available for training on real hardware, and few training simulators that provide an effective alternative exist. To establish the situational awareness necessary to plan and control the manipulator, conventional teleoperation also requires operators to mentally construct a 3D scene from a variety of 2D camera feeds, which is particularly challenging when such feeds are low resolution or framerate limited. This cognitive load imparted on operators is exacerbated in domains like underwater intervention where inadvertent collisions with the environment and vehicle can be catastrophic.

In contrast to conventional interfaces, the SHARC system according to the present invention enables users to operate with performance benchmarks (i.e., precision, accuracy, task time, and task completion rate) comparable to that of trained pilots regardless of their prior experience, even when faced with bandwidth limitations. For both pilots and novices, Task Completion Rates (R_{FPS}) while using SHARC-VR were generally higher than those obtained using the topside controller across tested framerates (FIGS. 7A-7B). These results suggest that SHARC increases the probability of successful task completion in operational settings, thereby minimizing time-consuming failures that can damage the vehicle platform or sensitive environments. Catastrophic failures that compromise platform survivability can jeopardize entire science campaigns, and thus SHARC may increase operations tempo while minimizing risk. At framerates below 10 FPS, pilots and novices using SHARC-VR had a faster Expected Task Time (E(T_{FPS})) than pilots using the conventional topside controller (FIGS. 8A-8C). Furthermore, as the framerate decreases, the topside controller's Expected Task Time increases exponentially from 107 s at 10 FPS to 432 s at 0.1 FPS for pilots, and 151 s to 1115 s for novices. In operational settings, these observed differences in Expected Task Time would likely be magnified since additional time would be needed to recover from failures, which are more likely to occur with the topside controller than with SHARC-VR.

The Expected Task Times with SHARC-VR exhibits a decreasing trend as the trials progressed independent of the framerate. Results show an average slope of −9.7 s/trial and −6.6 s/trial for pilot and novice groups, respectively (FIG. 9). This counterintuitive trend may be attributable to the order in which the trials were conducted. Participants completed the tests from high to low framerates, allowing them to gain familiarity with both the conventional topside controller and SHARC-VR. The Expected Task Times trend across framerates with SHARC-VR suggests that any speed decrease caused by lower framerates may have been offset by participant learning as the tests progressed.

As shown in Table 1 above, the differences between the Expected Task Times for the initial (E(T₁)) and final (E(T₆)) block pick-up trials at 10 FPS were greater when using the topside controller than when using SHARC-VR for both pilots and novices. This implies that the topside controller has an inherently steeper learning curve than SHARC-VR, and that operator performance is highly dependent on familiarity with the topside configuration (e.g., camera views, workspace layout, and controller settings). It is notable that one pilot failed the first block pick-up trial with the topside controller but succeeded in the final one, demonstrating that even trained pilots risk failure when not fully familiar with a conventional controller's configuration settings.

Both novices and pilots using SHARC-VR exhibited small but consistent speed improvements with each successive trial regardless of framerate, indicating that Expected Task Time is more strongly correlated with learning than the tested framerates. In contrast, Expected Task Times for the topside controller interface increased exponentially as framerate decreased, with this effect dominating any improvement achieved through learning.

In these experiments, VR users averaged ˜133 s to complete a block pick-up at 0.1 FPS, which translates to only 13 frames of data for the entire task. Theoretically, with a static scene, only three frames of data should be necessary: one to determine the target position in the workplace, a second to confirm the target has been grasped, and a third to confirm that the target has been retrieved successfully. This static scene assumption could be relaxed by implementing a process to identify changes to the scene and adapt the reconstruction or manipulation plan as necessary.

By reducing the required bandwidth needed for operation by two orders-of-magnitude (from 10 FPS to 0.1 FPS), SHARC shows the potential to enable tether-less manipulation operations. See also Table 3 above. Existing commercial through-water optical modems can transmit up to 10 Mb/s, which may support SHARC-VR at more than 10 FPS. Optimization may enable the use of lower bandwidth acoustic modems that can transmit at 5.3 kb/s, which would theoretically support an update rate of ˜0.02 FPS. Supporting this update rate at this bandwidth necessitates an update packet size of 265 kb or less, which should be sufficient for robotic manipulation with framerate-limited feedback, as described in the Billings 2022 Article. Under these bandwidth constraints, a standard cloud-based shore server using a gigabit uplink could support more than a million observers, any of whom can be designated as an operator. Field demonstrations highlight SHARC's utility in enabling delicate operations in unstructured environments under bandwidth-limited conditions, which may be extensible to other sensitive domains where dexterity is required such as nuclear decommissioning, deep space operations, and unexploded ordnance/disposed military munition remediation.

SHARC's reduced bandwidth requirement also facilitates real-time remote collaboration among shore-side users and enables it to scale to multiple simultaneous operations with additional operators and instrumentation. Supporting multiple remote operators can increase operations tempo by parallelizing sampling tasks and data analysis. For example, in a field demonstration, one scientist operated the in-situ XRF instrument and analyzed its data in real-time while another scientist concurrently planned manipulator trajectories to potential push core sites. Shore-based scientists also have access to resources that would be difficult for onboard operators to access over a ship's satellite internet connection, such as the cloud-based speech and natural language processing services used during this demonstration.

The SHARC system enables independent users to simultaneously plan manipulation tasks and visualize the simulated plans within a high-fidelity 3D representation of the workspace of a robot. Preferably, the SHARC system enables visualization of requested manipulator plans before the plans are dispatched to the robot; in some constructions, the plans are made available to other independent users, such as described above in relation to FIGS. 5 and 12A-12D, for example.

Within unstructured areas where scene understanding and contextual awareness are algorithmically challenging, risk in automated processes is greatly elevated. SHARC mitigates this risk by utilizing human perception for semantic-level scene understanding, with an operator guiding the system through the manipulation task using command primitives (e.g., go to an end-effector goal or open and close the gripper). Complex manipulation tasks in unstructured environments (e.g., collecting a physical sample or placing a sensor probe in contact with a bacterial mat) rely on the human operator to interpret the scene and guide the process. SHARC's approach to shared autonomy seamlessly adapts the level of human cognition in the control process according to the complexity of the task and prior knowledge of the workspace.

SHARC's capabilities within unstructured environments can be enhanced by including multi-sensor fusion (e.g., optical and acoustic) to reduce errors and uncertainty in scene reconstruction, natural object tracking for closed-loop visual servoing, and semantic mapping supported by natural language queues provided by the human operators. These capabilities build on the joint and complementary strengths of human perception and contextual awareness with machine processing and control to enable greater, low-risk automation of tasks within unstructured environments.

SHARC is platform-independent and can be readily integrated onto other underwater vehicles or other robots equipped with at least one robotic manipulator, a workspace imaging sensor, and a data link to the operators. Although the SHARC system has been described operating single-manipulator platforms, that is not a limitation of the invention. Other embodiments could extend the SHARC framework to multi-manipulator systems distributed across one or more vehicles with more than one concurrent operator. Coordinated manipulation could enable vehicles to manipulate objects too large or heavy for one manipulator to handle alone, complete tasks that require higher dexterity or redundant degrees-of-freedom (“DoF”) (e.g., three DoF, four DoF, five DoF, six or more DoF), and operate more efficiently by parallelizing tasks. For a single operator, a dual manipulator setup can potentially reduce cognitive load since human operators are already accustomed to bimanual control.

SHARC's task allocation architecture entails delegating responsibilities between the robot and operator based on their complementary strengths. Human operators are responsible for high-level scene understanding, goal selection (e.g., identifying sample locations), and task-level planning, which are challenging for existing perception and decision-making algorithms. These tasks are particularly difficult to automate in the unstructured environments typical of underwater marine environments. Meanwhile, SHARC relegates capabilities that can readily be solved using autonomy algorithms to the robot. By automating the inverse kinematics, motion planning, low-level control, and obstacle avoidance processes to the robot, SHARC can improve task efficiency. Critically, SHARC renders the robot's intended actions (e.g., the planned trajectory of the arm) prior to execution in context of its understanding of the surrounding environment (e.g., a 3D scene reconstruction along with the location and label of detected tools such as illustrated in FIGS. 12A-12D), thereby making its behavior more predictable than contemporary interfaces like the topside controller. With this task allocation approach, operators no longer need to simultaneously interpret the robot's many high-frequency sensor streams while solving the low-level manipulator kinematics necessary to move the end-effector. Instead, these tasks are offloaded to the robot, which should reduce operators' cognitive load during operation.

SHARC enables users to use natural language speech and gestures to convey high-level objectives to the robot. The inherent flexibility and intuitive nature of language enables users to succinctly issue complex commands that would otherwise be time-consuming and difficult to execute with conventional controllers. Within a matter of seconds, users can specify a task that takes the robot several minutes to execute. In addition to reducing the cognitive load required of the operator, the intuitive nature of natural language speech and gestures minimizes the training required for operation and makes SHARC accessible to a diverse population of users. These natural input modalities also have the benefit of remaining functional under intermittent, low-bandwidth, and high-latency communication, which helps SHARC enable participation from remote users.

SHARC enables shore-side users to view real-time data, participate in discussions, and control robotic manipulators with only an Internet connection and consumer-grade hardware, regardless of their prior piloting experience. In field trials, the ability to involve remote users became particularly important during the COVID-19 pandemic, when space onboard research vessels were restricted. Using SHARC, an entire team was able to contribute during field sampling operations, even though some team members were remotely located thousands of kilometers away on shore.

The SHARC technology described herein can be directly integrated onto terrestrial-, aerial-, space- and underwater-based manipulation platforms to decrease operational risk, reduce system complexity, and increase overall efficiency. The current standard for ROV manipulation requires one or more pilots to operate the UVMS based on image feeds from an array of cameras on the vehicle that are displayed on a set of monitors in a ship-side control van. Conventional systems do not provide pilots with an estimate of the 3D scene structure, putting the system at risk of collision between the arm and the vehicle or workspace objects. This, together with the cognitive load imposed by having to interpret multiple sensor streams, makes it extremely challenging for pilots to establish and maintain situational awareness.

The SHARC technology can be integrated at three different levels with existing ROV systems. At the first and most basic level, the system can act as a decision support tool that provides a detailed real-time 3D visualization of the scene, including the vehicle and manipulator configuration and a reconstruction of the workspace, enabling a pilot to position the manipulator with greater accuracy, speed, and safety. A variant of this is using SHARC as a “flight simulator” type tool of operator training. At the second level, the system can be integrated into the manipulator control system for execution monitoring to limit the motion of the manipulator based on scene structure, preventing the pilot from moving the manipulator into collision or a risky configuration. At the third and highest level, manipulation tasks may be fully automated so that a pilot simply selects a desired function or indicates an intent through some mode of communication such as natural language, whereupon the system plans and executes the task while providing visual feedback to the pilot.

Although specific features of the present invention are shown in some drawings and not in others, this is for convenience only, as each feature may be combined with any or all of the other features in accordance with the invention. While there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps that perform substantially the same function, in substantially the same way, to achieve the same results be within the scope of the invention. Substitutions of elements from one described embodiment to another are also fully intended and contemplated. It is also to be understood that the drawings are not necessarily drawn to scale, but that they are merely conceptual in nature.

It is to be understood that the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions. Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on, or executable by, a programmable computer including any combination of any number of the following: a processor, a storage medium readable and/or writable by the processor (including, for example, volatile and non-volatile memory and/or storage elements), an input device, and an output device. The input device and/or the output device form a user interface in some embodiments. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention automatically generate a three-dimensional workspace image of a workspace at a site utilizing at least one imaging sensor directed at the site, automatically update image data in an electronic memory representing the workspace, and automatically and wirelessly transmit such data to a remote server over a wireless network for storage and processing. Such features can only be performed by computers and other machines and cannot be performed manually or mentally by humans.

Any claims herein which affirmatively require a computer, a processor, a controller, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a controller, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays).

A computer can generally also receive (read) programs and data from, and write (store) programs and data to, a non-transitory computer-readable storage medium such as an internal disk (not shown) or a removable disk or flash memory. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium or other type of user interface. Any data disclosed herein may be implemented, for example, in one or more data structures tangibly stored on a non-transitory computer-readable medium. Embodiments of the invention may store such data in such data structure(s) and read such data from such data structure(s).

It is the intention, therefore, to be limited only as indicated by the scope of the claims appended hereto. Other embodiments will occur to those skilled in the art after reviewing the present disclosure and are within the following claims.

Every issued patent, pending patent application, publication, journal article, book or any other reference cited herein is each incorporated by reference in their entirety.

What is claimed is:

1. A system configured for remote human collaborative manipulation of a component of a robot in a workspace at a site, the system comprising:
a 3D module configured to generate a three-dimensional workspace image of the workspace utilizing at least one imaging sensor directed at the site;
a local server that communicates directly with the robot and has at least one local user interface through which the three-dimensional workspace image is viewable;
at least one remote server that communicates wirelessly with the local server and with at least one remote user interface through which the three-dimensional workspace image is viewable; and
a robot autonomy module that receives interface inputs from the local user interface and the remote user interface, develops an action plan utilizing the interface inputs, and coordinates with the local server to provide instructions to the robot.

2. The system of claim 1 wherein the local server includes a personal computer configured to operate at least a portion of the robot autonomy module.

3. The system of claim 1 wherein the 3D module is configured to receive inputs from a stereo camera directed at the workspace.

4. The system of claim 3 wherein the 3D module is further configured to receive input from a camera mounted on the component of the robot to view at least a portion of the workspace.

5. The system of claim 1 further including the robot, and the component is an articulated manipulator assembly.

6. The system of claim 5 wherein the robot is configured to operate in a liquid at a site below a surface of the liquid.

7. The system of claim 6 wherein the robot is an underwater vehicle operatable without a human occupant.

8. The system of claim 5 wherein the robot is configured to operate in an extraterrestrial environment.

9. The system of claim 1 wherein the system is configured to update the three-dimensional workspace image according to bandwidth availability and/or latency for communications among the user interfaces, the local server, the remote server, and the robot.

10. A method for remote human collaborative manipulation of a component of a robot in a workspace at a site, the method comprising:
reproducing a three-dimensional workspace image of the workspace utilizing at least one imaging sensor directed at the workspace at the site;
selecting a local server to communicate directly with the robot and with at least one local user interface through which the three-dimensional workspace image is viewable;
selecting at least one remote server to communicate wirelessly with the local server and with at least one remote user interface through which the three-dimensional workspace image is viewable;
designating a plurality of users as members of an operations team; and
receiving interface inputs from the local user interface and the remote user interface from the members of the operations team, developing an action plan utilizing the interface inputs, and coordinating with the local server to provide instructions to the robot.

11. The method of claim 10 wherein at least one user is designated as a field team member of the operations team and at least one remote user is designated as a remote team member of the operations team.

12. The method of claim 11 wherein the field team member selectively delegates control authority to one of the remote team members to serve as a remote operator having active task control of at least one parameter of the robot.

13. The method of claim 11 further including designating other users as observers who receive data streams and the three-dimensional workspace image through at least one additional interface but without the ability to issue instructions to the robot.

14. The method of claim 11 wherein at least one field team member is responsible for operations support including overseeing safety, managing communications, and selectively delegating control authority to other users.

15. The method of claim 11 wherein at least one remote team member is responsible for at least one of operating payload instruments or generating task-level plans for use of the component of the robot.

16. The method of claim 10 wherein the three-dimensional workspace image is updated according to bandwidth availability and/or latency for communications among the user interfaces, the local server, the remote server, and the robot.

17. The method of claim 10 wherein the component is an articulated manipulator assembly.

18. The method of claim 10 wherein the robot is configured to operate in a liquid at a site below a surface of the liquid.

19. The method of claim 10 wherein the robot is an underwater vehicle that is operated without a human occupant.

20. The method of claim 10 wherein the robot is configured to operate in an extraterrestrial environment.

21. The method of claim 10 wherein control authority is retained by at least one local user to serve as an operator having active task control to manipulate the component of the robot.

22. The method of claim 21 wherein the action plan is developed utilizing only local user inputs.

23. The method of claim 22 further including deselecting receipt of interface inputs from the remote user interface.
